(19) United States
(12) Patent Application Publication
(10) Pub. No.: US 2006/0066899 A1
(43) Pub. Date: Mar. 30, 2006

(54) Printing control apparatus and computer readable information recording medium

(76) Inventor: Takuya Yoshida, Tokyo (JP)

Correspondence Address: DICKSTEIN SHAPIRO MORIN & OSHINSKY LLP, 2101 L Street, NW, Washington, DC, 20037, US

(21) Appl. No.: 11/234,120

(22) Filed: Sep. 26, 2005

(30) Foreign Application Priority Data
Sep. 30, 2004 (JP) 2004-286037
Aug. 30, 2005 (JP) 2005-248610

(51) Int. Cl. G06F 3/12

(52) U.S. Cl. 358/1.15

(57) ABSTRACT

A registering part registers setting information concerning preview display of document data; and a printing setting part responds to a printing request for the printing data, to output, to a display part, an printing setting page for setting printing conditions for the document data, wherein: the printing setting part refers to the setting information registered in the registering part when receiving a printing instruction for the document data, and, outputs the printing setting page providing a button for receiving an instruction for a preview display for the document data without carrying out a preview display of the document data when a preview display for the document data has not been set in the registering part.

### BACKGROUND OF THE INVENTION

1. Field of the Invention

The present invention relates to a document printing control apparatus, and, in particular, to a document printing control apparatus including a part provided for allowing a preview display for a user to set printing conditions by an input operation for a document under management.

2. Deception of the Related Art

Conventionally, when document data produced with the use of various types of applications such as a word processor software, spreadsheet and so forth of a computer, is printed out, actual printing is carried out with the use of a printer driver installed in the computer with which a document has been produced or another computer connected via a communication network.

When printing is carried out with the use of a printer driver, typically, document data produced with the use of an application is converted into drawing data by means of a graphic engine provided by an OS (operating system), the drawing data is then converted into printing control data depending on a printer actually applied, such as PDL (page description language) or such, by a function of the printer driver, and the thus-obtained data is transmitted to the printer designated by the user.

Further, when document data produced with the use of various types of applications is stored in a predetermined database provided locally or provided via a communication network, printing processing is carried out also in the above-mentioned processing flow when the document data is printed out, as being well known.

In connection with such document data printing processing, a so-called printing preview function, which is not provided by various sorts of applications prepared for document production, is provided by a document management application or a printer driver. This printing preview function is a function of, for example, generating image data reflecting the contents of printing conditions set for document data, and displaying a printing result in a from of a preview image in a printing setting page; or further displaying a preview image simultaneously reflecting the contents of user's setting for various printing conditions made by a user on the printing setting page. In this regard, see Japanese Laid-open Patent Applications Nos. 2000-298564 and 2003-248564. Especially, Japanese Laid-open Patent Application No. 2003-248564 discloses that, as printing conditions, post processing such as stapling processing, hole punching and so forth, are prepared.

In order to provide such a preview image, such a process has been applied that, in an on-the-way stage of the above-mentioned processing of converting to the printing control data, data obtained from an application after being converted into drawing data by means of a graphic engine provided by an OS is then converted into data in a form called printing intermediate data by means of a printer driver, the thus-obtained data is then modified based on the contents of printing conditions such as post processing, set by a user, and the thus-obtained modified intermediate data is converted into image data for displaying on the computer.

### SUMMARY OF THE INVENTION

However, in a conventional printing preview function, the printing intermediate data is applied as a preview image. As a result, a printing setting page is displayed after the completion of modification of the generated printing intermediate data for all the pages of a relevant document. Thus, display of the setting page may be delayed depending from generation of preview images, and thereby, a long time may be required until finally the setting page is displayed so that actual setting operation can be carried out therewith.

The present invention has been devised in consideration of and for solving such a problem occurring in a printing control apparatus for receiving user's setting for printing conditions with the use of a setting page providing a printing preview function. Objects of the present invention are that, preview display processing may be omitted for a user who does not wish a printing preview function, and thus, a printing setting page may be promptly displayed, and also, convenience for a user who wishes the printing preview function may not be degraded.

According to a first aspect of the present invention, in a printing control apparatus, a registering part registering setting information concerning preview display of document data; and a printing setting part responding to a printing request for the document data, to output, to a display part, a printing setting page for a user's setting of printing conditions for the document data, wherein: the printing setting part refers to the setting information registered in the registering part when receiving a printing instruction for the document data, and, outputs the printing setting page providing a button for receiving a user's instruction for a preview display for the document data without actually carrying out preview display of the document data when preview display for the document data has not been set in the registering part.

According to a second aspect of the present invention, in the printing control apparatus according to the above-described first aspect of the present invention, a converting part, may be preferably provided additionally, converting the document data for which the printing instruction has been received, into intermediate data; wherein: the printing setting part may respond to a user's instruction for a preview display of the document data by means of the above-mentioned button, to send an instruction to the converting part for converting the document data into intermediate data, and generate a preview image to be applied for a preview display of the document data, based on the intermediate data obtained from the converting part, responding to the instruction.

According to a third aspect of the present invention, in the printing control apparatus according to the above-described second aspect of the present invention, the printing setting part may output a printing setting page by which a user's selection is allowed for preview display with icon data in imitation of the preview image, instead of preview display of the preview image itself.

According to a fourth aspect of the present invention, a computer readable information recording medium may be provided for storing therein a program for causing a computer to function as the printing control apparatus according to any one of the above-described first through third aspects of the present invention.

(1) According to the present invention described above, after receiving a printing instruction, setting information is first referred to, and a printing setting page is immediately displayed when preview display setting is not included in the setting information. Further, a user's additional instruction is allowed for requesting preview display in the thus-once displayed printing setting page. Therefore, there should occur no waiting time for the user until the printing setting page is actually displayed, and the printing setting page can be thus displayed promptly. Also, preview display is allowed in response to a user's input operation as an additional request. Accordingly, no useless processing should be carried out, and thus, the printing efficiency improves. Further, when preview display is set by a user as setting information previously, a printing setting page with a preview display is displayed without requiring any additional operation by the user. Further, preview display can be requested also from a printing setting page once displayed. By thus adding such selectivity, convenience for a user improves, and the performance of the apparatus improves.

(2) Further, instead of preview display by a preview image itself, preview display by icon data in imitation of the preview image may be available. Thereby, it is possible to respond to a request that merely a rough view of a printing output result should be displayed in advance. Such preview display by icon data can be displayed rapidly in comparison to a case where preview display is made with an ordinary preview image. Accordingly, a waiting time can be effectively shortened.

(3) By loading a computer readable information recording medium storing therein a program prepared for causing the computer to function as the printing control apparatus according to any one of the above-mentioned first through third aspects of the present invention, and driving the computer according to instructions included in the program, the printing control apparatus providing the above-described effects/advantages in the above-mentioned items (1) and (2) can be easily realized.

### BRIEF DESCRIPTION OF THE DRAWINGS

Other objects and further features of the present invention will become more apparent from the following detailed description when read in conjunction with the accompanying drawings:.

FIG. 1 shows a block diagram of a general configuration of a printing control apparatus according to an embodiment of the present invention;

FIG. 2 shows one example of a page displaying a document management state in a document management application;

FIG. 3 shows an operation flow concerning display mode setting processing for printing preview;

FIGS. 4A and 4B show a printing processing flow (first embodiment) concerning a printing control apparatus according to the present invention;

FIG. 5 shows a printing setting page (first embodiment) enabling printing preview display;

FIG. 6 shows an operation flow of processing (first embodiment) for generating a preview image reflecting printing condition setting;

FIG. 7 shows a printing setting page (second embodiment) enabling printing preview display;

FIG. 8 shows a printing setting page (third embodiment) enabling printing preview display; and

FIG. 9 shows an operation flow of printing processing concerning a printing control apparatus according to the present invention (third embodiment).

### DETAILED DESCRIPTION OF THE PREFERRED EMBODIMENTS

Embodiments of a printing control apparatus according to the present invention are described now.

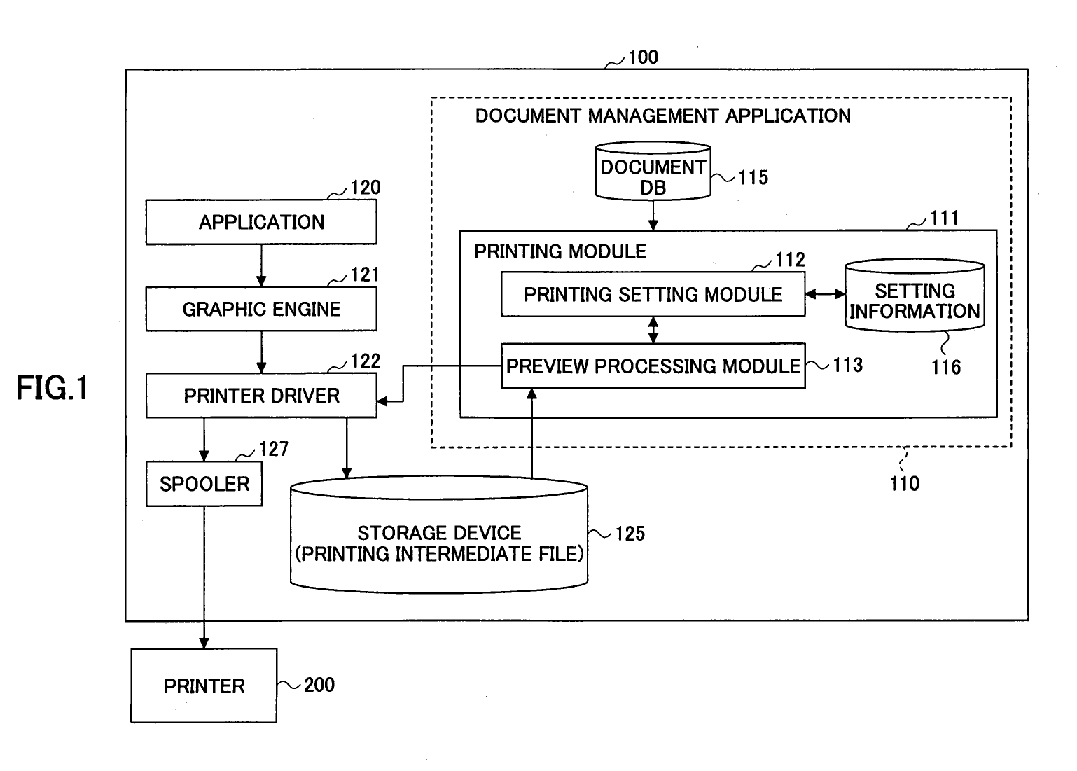

FIG. 1 shows a block diagram of a general configuration of a printing control apparatus according to an embodiment of the present invention. The embodiment shown in FIG. 1 is an example in which a printing control apparatus according to the present invention is realized as a client PC (personal computer) 100. The client PC 100 is connected with a printing machine 200 (simply referred to as a ‘printer’, hereinafter) via a communication network (wired or in wireless), or via a cable. The client PC 100 has respective functions described later as a result of a program according to the present invention being installed in the computer having a CPU, a ROM, a RAM and so forth, built therein, and being executed by the CPU.

In the client PC 100, various types of applications 120 such as word processor software, spreadsheet, and so forth, applicable for document production; a graphic engine 121 converting document data into drawing data according to a printing instruction for the document data, and transferring the thus-obtained drawing data to a printer driver; the printer driver 122 converting the drawing data received from the graphic engine 121 into printing control data such as PDL which the printer 200 can interpret; and a document management application 110 (enclosed by a broken line in FIG. 1) providing a printing preview function described later, operate. It is noted that the above-mentioned ‘document data’ means data, image data such as TIFF (tag image file format), PDF (portable document format) or such, produced with the use of the above-mentioned various types of applications. The printer driver 122 not only outputs printing control data such as PDL interpretable by the printer 200 to the printer 200 via a spooler 127 but also carries out operation to a storage 125 as a storing part which stores so-called intermediate data to be applied as data for printing preview described later. The intermediate data means data obtained during the above-mentioned converting process to obtain the printing control data, such as PDL, before the printing control data is finally obtained.

The document management application 110 has a document data registration part 115 (referred to as ‘document DB (database), hereinafter) unique to this application, and has a function of registering document data in the document DB 115, or handling document data thus registered as a document, under a data management system of the document management application 110.

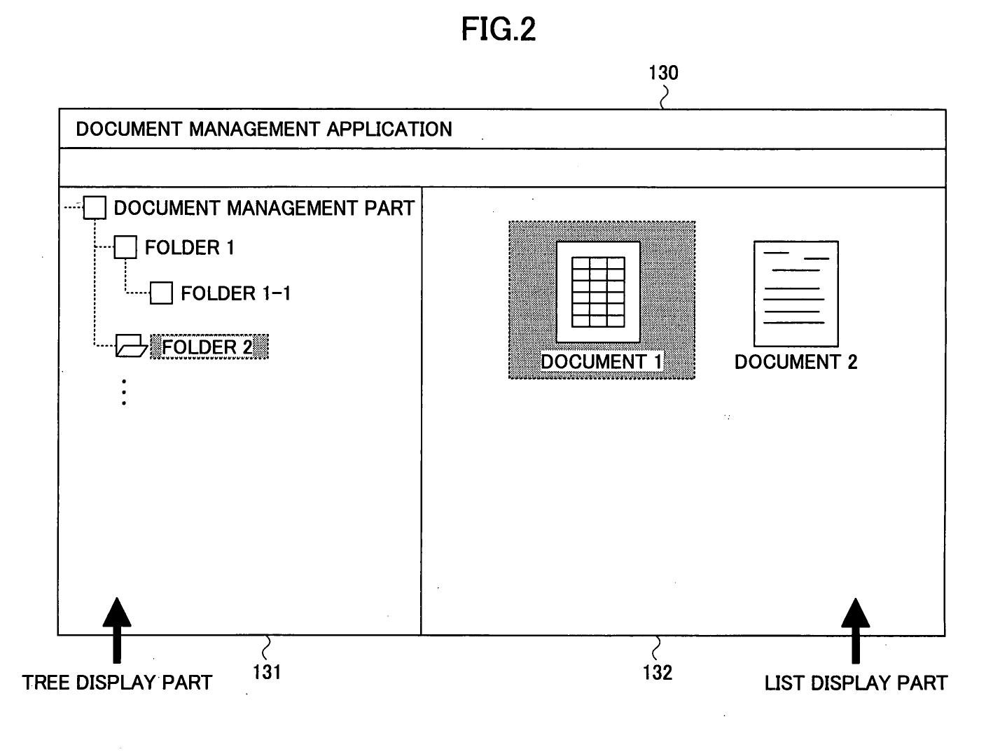

FIG. 2 shows one example of a page 130 displaying, on a display device of the client PC 100, a document management state of documents managed by the document management application 110. On the page 130 shown, a tree display part 131 and a list display part 132 are provided. In the tree display part 131, storage locations (folders) of the documents registered in the document DB 115 are displayed hierarchically in a tree manner. Thereby, it is easy to find out and designate a required folder from among all the folders. The list display part 132 displays a list of the documents included in the folder designed from the tree display part 131, and thus, a user can easily designate a required document therefrom.

Document data handled by the document management application may mean a collection of application data such as Word files, Excel files, or such, image data such as TIFF, PDF or such, or, may mean only each single file of the data.

Further, the document management application 110 has a printing module 111 providing a UI (user interface) required when a user gives an instruction for printing out document data registered in the document DB 115.

The printing module 111 displays a printing setting page for a user to set printing conditions, and provides a printing preview function of generating image data for preview (referred to as a preview image, hereinafter) reflecting the contents of printing post processing such as stapling processing, hole punching processing or such, set as the printing conditions, and displaying a printing result in advance according to the setting in a form of a preview image in the printing setting page, or displaying a preview image simultaneously reflecting various sorts of printing conditions currently set by a user on the printing setting page.

This printing preview function is provided as a result of the printing module 111 including a printing setting module 112, a setting information DB (database) and a printing processing module 113.

The preview processing module 113 has a function of giving an instruction to the printer driver 122 for causing it to convert document data obtained from the document DB 115 into intermediate data, and receiving the intermediate obtained as a result of the conversion from a printing intermediate file storage device 125; a preview function of displaying, on the display device of the client PC 100, a preview image or a printing setting page for preview printing; and a drawing data producing function for generating a preview image based on the intermediate data obtained from the printing intermediate file storage device 125.

The printing setting module 112 has a function of reflecting the printing setting contents received via a keyboard or a pointing device such as a mouse operated by a user on a preview image displayed on the display device, and a function of registering setting information for a display mode of printing preview described later in the setting information DB 116, or controlling preview display in a display mode registered in the setting information DB 116.

According to the present invention, preview setting can be previously made by a user for a display mode of printing preview, the setting is then registered in the setting information DB 116, and operation according to the thus-set display mode is carried out when this setting information is referred to immediately after a printing instruction is made by a user. In the display mode, such setting is allowed, as to whether or not a preview image is displayed at the same time with display of a printing setting page.

Below, a basic mode for carrying out, based on setting information, which is set previously, operation concerning a display mode according to the setting information, is described, as a first embodiment of the present invention.

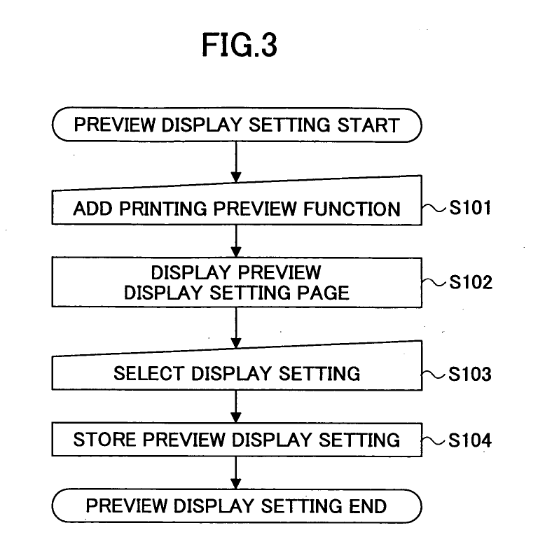

FIG. 3 shows an operation flow concerning display mode setting processing carried out for activating printing preview according to the present embodiment. A procedure of display mode setting processing is described now with reference to the processing flow of FIG. 3.

When the document management application 110 is started up by a user, an initial page of this application, shown in FIG. 2, is displayed on the display device. In this initial page, the tree display part 131 displaying document storage locations (folders) in which documents registered in the document DB 111 are hierarchically displayed in a tree manner. When the use selects a desired folder from the tree display part 131, a list of the documents included in the folder is delayed in the list display part 132 in a form of thumbnails, icons or such. The user then selects a document therefrom for printing out the same. In the example of FIG. 2, a document 1 has been selected (enclosed by a gray background) from the document data stored in the folder.

Further, upon carrying out the document selection operation, display mode setting operation for applying the printing preview function is carried out with the use of an icon, a menu bar or such, not shown (Step S101).

In response to this operation, the printing setting module 112 displays, on the display device of the client PC 100, a page for setting a preview display mode, that is, a page for a user to set as to whether or not a preview image is to be displayed at the same time with display of a printing setting page (Step S102).

By detecting the user's operation on the setting page, setting for the thus-selected display mode is received (Step S103), and information of the thus-set display mode is registered in the setting information DB 116 (Step S104). With the use of the information registered in the setting information DB 116, selective display inquiring as to whether or not a preview image is displayed is made, at the same time with display of a printing setting page made according to a printing preview instruction described later.

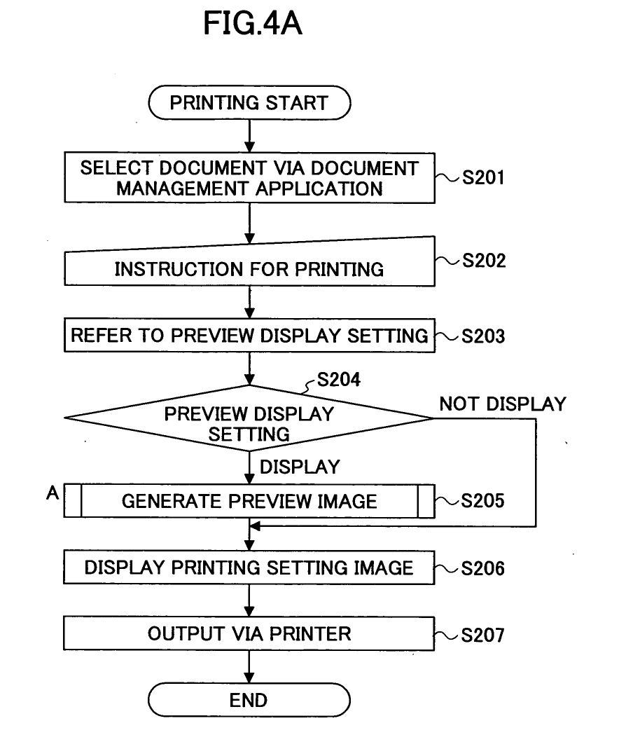

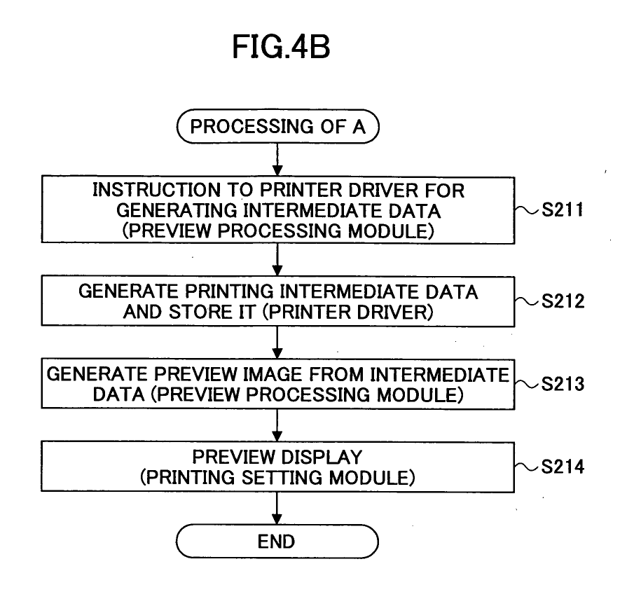

Next, the entire printing processing carried out according to printing conditions set by a user with the use of the UI having the printing preview function is described with reference to FIGS. 4A and 4B showing a processing flow chart.

According to the flow chart shown in FIGS. 4A and 4B, first, a user selects target document data from among those registered in the document DB 115 from the initial page (FIG. 2) displayed after the document management application 110 is started up (Step S201), and thus, the user gives an instruction for printing out the document data (Step S202). Here, as shown in FIG. 2, the ‘document 1’ is selected from the ‘folder 2’ from the document DB 115. Further, although not shown in FIG. 2, an instruction is given for printing out the document data, with the use of the printing preview function. That is, since the present embodiment allows an instruction for ignoring the preview function, an instruction should be made for applying the preview function if necessary.

In response to these printing instructions, the printing setting module 112 refers to the display mode setting for printing preview previously stored, as a result of the processing flow shown in FIG. 3 being carried out, from the setting information DB 116 (Step S203). When setting of ‘not to display’ is obtained as a result of this reference (‘not display’ in Step S204), the printing setting module 112 skips preview image production processing, and carries out printing setting page displaying processing in Step S206.

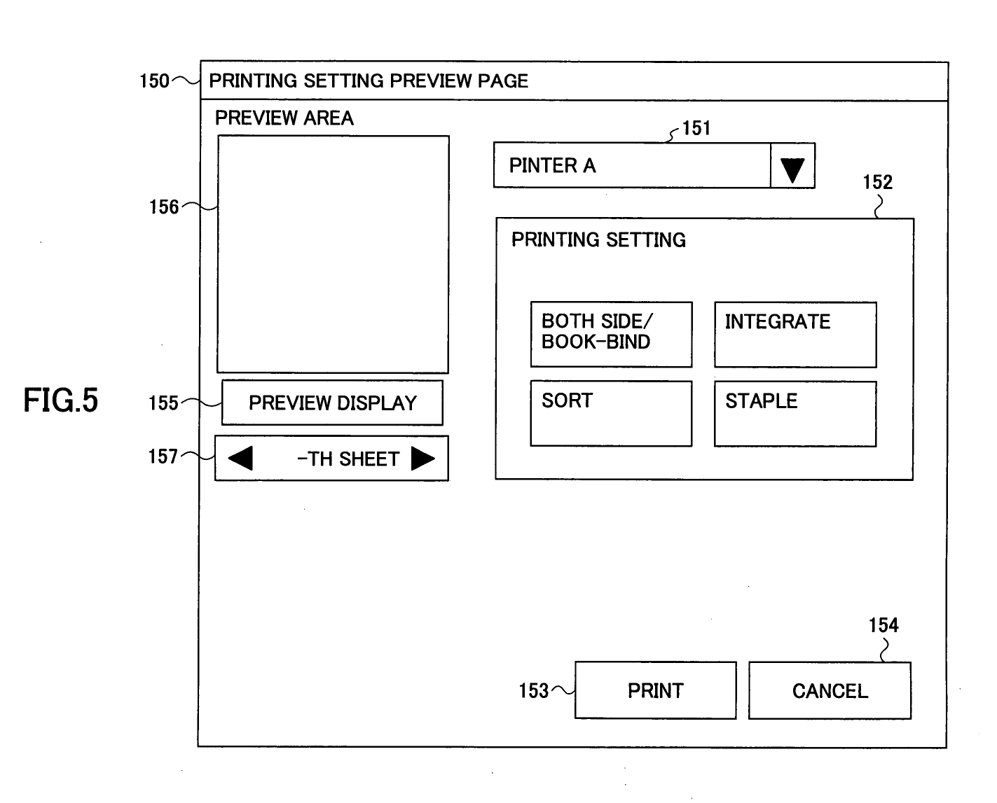

Specifically, the printing setting module 112 does not gives an instruction for converting into intermediate data to the preview processing module 113, that is, does not output an instruction for converting the selected document 1 into intermediate data to the printer driver 122, but outputs only a printing setting page on the display device. At this time, the printing setting module 112 prepares for a possible preview display instruction given from the printing setting page as described later. That is, the printing setting module 112 writes, in the setting information DB 116, information concerning a storage location of the selected document 1 in the document DB 115 and thus, memorizes the information. The information of the storage location may be preferably in a form such as a path for the document data in the document DB 115. Through these processes, a printing setting page 150 in one example is displayed on the display device of the client PC 100 as shown in FIG. 5 (details are described later).

When setting of ‘displaying a preview image’ (‘display’ in Step S204) is obtained as a result of the setting information DB 116 being referred to in Step S203, preview image data production processing is started up (Step S205). A subroutine of the preview image data producing processing corresponds to a processing flow indicated as ‘A’ in FIG. 4B.

In the processing flow ‘A’, in order to produce a preview image, the preview processing module 113 first gives an instruction to the printer driver 122 for causing it to convert the selected document 1 into intermediate data (Step S211). When giving the instruction for converting into intermediate data to the printer driver 122, the preview processing module 113 outputs the information of storage location of the document 1 from which the document data was selected in Step S201.

Next, the printer driver 122 generates intermediate data based on the converting instruction accompanied by the information of storage location of the document 1, and stores the intermediate data in the printing intermediate file storage device 125 (Step S212). Further, in this occasion, a storage location of the intermediate data thus obtained as a result of this processing is notified of to the preview processing module 113 in a referable form such as a path.

The preview processing module 113 receives this, designates, as an argument, the information of storage location of the intermediate data obtained from the printer driver 122, accesses the printing intermediate file storage device 125, and converts the thus-obtained intermediate data into a preview image with the use of a drawing data producing function (Step S213).

After that, the printing setting module 112 carries out display control such that the thus-obtained preview image data may be output in a preview image display area 156 of a printing setting page 150 (Step S214).

Thus, for a case where setting for displaying a preview image has been made, a printing setting page with a preview image produced in the processing of subroutine ‘A’ is displayed in the printing setting page 150 (Step S206).

Further, in the processing flow according to the present embodiment, an execution key for printing is provided in the printing setting page 150 for setting printing conditions, and, by a user's operation of this execution key, an output request is generated for the printer 200 (Step S207) via the printer driver 122 and the spooler 127, and after that, the printing processing flow by the document management application 110 is finished.

The printing setting page displayed in Step S206 of the above-described processing flow is described now with reference to FIG. 5.

The printing setting page 150 provides a UI having the printing preview function, and, in this page, a printer designation field 151 for selecting a printer to which a printing instruction is actually sent, a printing condition setting display field 152 for setting an output mode such as both-side printing, book-binding printing, integrating printing, post processing such as sorting processing, stapling processing or such, a printing button 153 for giving an instruction for printing execution to the printer designated in the printer designation field 151, a cancel button 154 for canceling printing execution and closing the printing setting page 150, a preview display button 155 for receiving from a user a preview image display instruction, a preview image display area 156 for displaying a preview image in response to the preview display button being pressed, and a page switching button 157 for switching a page of a preview image to display, displayed in the preview image display area 156.

The printing setting page 150 shown in FIG. 5 is in a state in which no image is displayed in the preview image display area 156. This display state is a state which first occurs when a document has been selected and a printing instruction has been made. For a case where setting of not displaying a printing preview image is made, this display state is kept unchanged as it is.

When the preview display button 155 is pressed by a user and a preview image display instruction is made in the state in which no image is displayed in the preview image display area 156, preview image producing and display processing is started up.

A specific processing flow carried out when the preview display button 155 is pressed is basically the same as the subroutine ‘A’ processing of FIG. 4B which is carried out when setting of displaying a preview image is previously set. Since the processing is described above, duplicated description is omitted by reefing to the description thereof hereby.

However, in the main flow of FIG. 4A, a processing flow is necessary for responding to the preview display button 155 being pressed. This can be achieved as a result of a flow being provided, in which, after the printing setting page is displayed in Step S206, the preview image producing step S206 is returned to in response to the user's instruction, i.e., the preview display button 155 being pressed.

In the present embodiment, the printing setting page can be rapidly displayed as a result of user's setting being previously made such that no preview image may be displayed. Furthermore, as a result of the preview display button 155 being provided in the printing setting page 150 shown in FIG. 5 as mentioned above, an instruction for preview display can be made after that, when the necessity arises, whereby the preview function can be utilized. Thus, a request of a user who wishes such a display mode can be properly met.

Next, a preview display operation when setting of printing conditions is made on the printing condition setting display field 152 provided in the printing setting page (FIG. 5) is described.

This operation allows, for setting of printing conditions, user's printing setting with viewing an image displayed in the preview image display area 156 with a printing condition currently set by a user being reflected on the preview image.

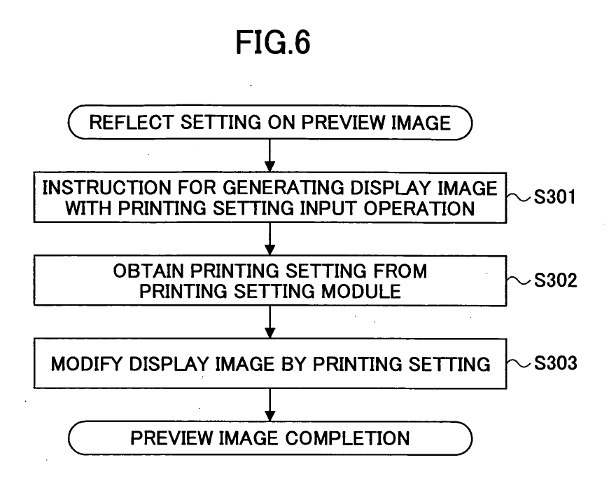

FIG. 6 shows a processing flow of generating a preview image reflecting a printing condition set currently, in the present embodiment.

When setting printing conditions, a user selects a desired printing setting item from the printing condition setting display field 152 provided in the printing setting page (FIG. 5). This selection operation shows a possibility that the preview image may be changed by new printing setting made by the user, and thus, a preview image generating instruction is given to the printing setting module 112 based on this selection operation (Step S301) in this processing flow of FIG. 6.

In response this instruction, the printing setting module 112 obtains printing setting information thus set by the user's input operation (Step S302).

Then, based on the thus-obtained printing setting, preview image data reflecting this printing setting is generated for updating the preview image data currently displayed in the preview display area 156 (Step S303).

Specifically, the preview processing module 113 gives the printer driver 122, as arguments of an intermediate data modifying instruction, the printing setting information obtained via the printing setting module 112 as well as the document data storage location information, and thus, the preview processing module 113 causes the printer driver 122 to carry out modification into intermediate data reflecting the printing setting. After that, the preview processing module 113 receives the intermediate data generated by the printer driver 122 through the modification via the printing intermediate file storage device 125, converts it into preview image data by the above-described drawing data producing function, and carries out display control for outputting it in the preview display area 156. Thus, display of the preview image data reflecting the set contents of the printing setting item selected by the user is achieved.

The preview image data generating processing (FIG. 6) for generating preview image data reflecting user's printing setting is carried out after the printing setting page display step (Step S206) in the main flow of FIG. 4A. Also, display of a preview image is made with updated data. Accordingly, a processing flow of returning to the printing setting page display step S206 should be provided.

When the user makes desired printing setting while viewing the preview image after the updated preview image is thus displayed in the printing seating page 150, and presses the printing button 153, a printing instruction is issued for the printer designated in the printer designation field 151. In this case, the printing instruction is received by the preview processing module 113, and the preview processing module 113 issues the received printing instruction for the printer driver 122. The printer driver 122 responds to this printing instruction, converts the intermediate data into printing control data such as PDL, and outputs it to the printer 200. Thus, a sequence of processing started from displaying the printing setting page and ended by the actual printing execution is completed.

When a printing instruction ignoring the preview function is given, or a printing instruction is give such that the preview display button 155 is not pressed on the printing setting page, an ordinary printing processing for document data is carried out. That is, application data is input to the printer driver 122 via the graphic engine 121, the printer driver 122 converts it into printing control data which is data in a form depending from the printer, and then, the data is output to the printer 200. In this case, processing of storing the intermediate data generated by the printer driver 122 in the printing intermediate file storage device 125 is not carried out.

Thus, according to the first embodiment, the selectable preview display mode may be previously set such that “preview display should not be carried out”. Thereby, an instruction for obtaining intermediate data from which a preview image is produced is not output at a time at which the document management application 110 makes an instruction for printing allowing printing preview. That is, the selected document data is output to the printer driver 122, and an instruction for generating intermediate data is not output in synchronization with an instruction for printing allowing printing preview.

Accordingly, at this time, no preview image is displayed in the preview image display area 156 of the printing setting page 150. After that, when a user presses the preview display button 155 provided in the printing setting page 150, preview image generating processing, i.e., generation of intermediate data a by the printer driver 122 and processing of converting the intermediate data into preview image data by the preview processing module 113 are started. Thus, preview image generating processing is postponed while display of the printing setting page 150 is carried out first. Thereby, a time required for displaying the printing setting page 150 can be shortened.

Next, a second embodiment is described. In the second embodiment, based on the above-mentioned first embodiment, setting operation for preview selecting a preview image display mode is made possible from the printing setting page 150, and also, preview display ON/OFF operation is made possible from the printing setting page 150. Thereby, user's convenience is improved, and also, a load for preview image display processing is reduced.

In the above-mentioned first embodiment, a preview image display mode is previously set in such a manner that, from an icon, a menu bar or such, displayed in the initial page of the document management application 110, the relevant setting page is displayed. In the first embodiment, when a user wishes to change the preview image display mode setting with a display of the printing setting page 150, the page for the preview image display setting may not be displayed immediately.

According to the second embodiment, the preview image display mode setting from the printing setting page 150 is made possible, and thus, user's convenience is further improved.

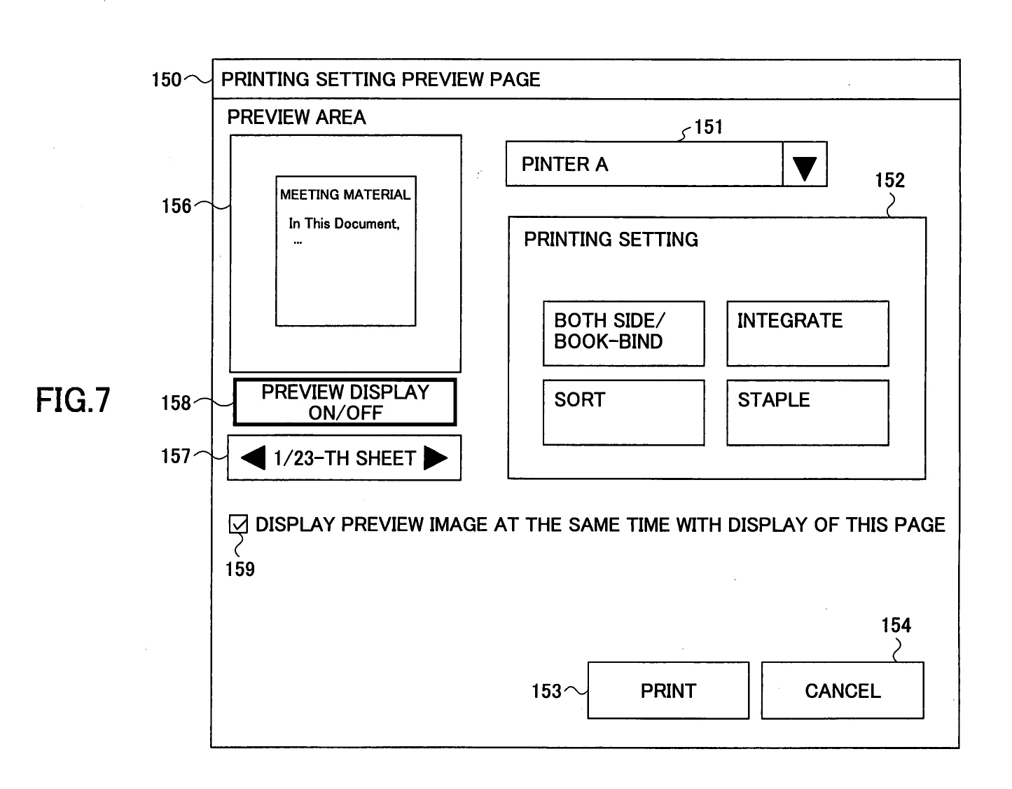

FIG. 7 shows the printing setting page according to the second embodiment. In the second embodiment, processing for displaying the printing setting page is basically the same as that in the printing processing according to the first embodiment, i.e., the processing flow of FIGS. 4A and 4B, which is carried out according to the printing conditions set via the UI allowing printing preview. Accordingly, duplicated description is omitted by hereby referring to the description for the processing flow of FIGS. 4A and 4B.

As shown in FIG. 7, on the printing setting page 150 displayed, a check box 159 is newly provided for previously selecting a preview image display mode. Further, instead of the preview display button 155, a preview display ON/OFF button 158 modified from the preview display button 155 to have multiple functions is provided. The preview display ON/OFF button 158 will be described later.

The check box 159 is thus provided for the purpose of selecting a preview image display mode by a user as to whether or not a preview image is displayed when the printing setting page 150 is displayed for subsequent occasions. When this check box 159 is checked on the printing setting page 150 shown in FIG. 7, the printing setting module 112 detects it, thus receives the thus-selected display mode, and registers the set display mode information in the setting information DB 116.

Then, when an instruction for printing processing allowing printing preview is given after this setting is made, the printing setting module 112 reads the information registered in the setting information DB 116, and carries out display control in a mode such that a preview image of selected document data is displayed in the preview image display are 156. It is noted that control for the selected display mode is carried out the same as Steps S203 through S206 in the above-mentioned printing processing flow of FIGS. 4A and 4B.

As mentioned above, in the second embodiment, display control for a preview image in the preview image display area 156 is carried out according to a check in the check box 159 on a display of the printing setting page 150 in a pervious occasion. However, there may occur a case where, from among a plurality of pages of preview images which will be displayed, user wishes to make a check for an already made printing setting with reference to preview display, only for a first page or first several pages. In such a case, a load for preview image display processing can be reduced as a result of display control being carried out in such a manner that unnecessary preview images are not displayed while printing setting operation is allowed. Therefore, by providing the preview display ON/OFF button 158, this display control operation can be achieved.

In the printing setting page 150 of FIG. 5, a case is shown in which a preview image is displayed in the preview image display area 156 currently. In this case, when a user presses the preview display ON/OFF button 158, the printing setting module 112 receives this operation input as a preview display OFF (i.e., inactivation) instruction, generates a new printing setting page 150 in which no preview image is displayed in the preview image display area 156, and displays it on the display device.

On the contrary, when the preview display ON/OFF button 159 is pressed for a case where no preview image is displayed in the preview image display area 156, the printing setting module 112 receives this operation input as a preview display ON (i.e., activation) instruction, carries out preview image display processing for the preview image display area 156, and thus displays a preview image there. In this case, control processing the same as that in the first embodiment carried out in response to the preview display button 155 (see FIG. 5) being pressed is carried out. Accordingly, the duplicated description is omitted by hereby referring to the description concerning the control processing according to the first embodiment.

Thus, according to the second embodiment, preview image display in the preview image display area 156 occurring when the printing seating page 150 is opened can be made selective by means of user's operation on the check box or the button provided in the printing setting page 150. Accordingly, user's convenience can be improved, and also, a load for preview image display processing can be reduced.

Next, a third embodiment of the present invention is described. In the third embodiment, based on the second embodiment (also based on the first embodiment on which the second embodiment is based), as a preview image display mode, a mode of displaying a preview image with the use of image data in a form of an icon (this form of a preview image is described later) is added.

Further, in the third embodiment, setting operation is made possible by which a preview image display mode is previously selected from among preview display modes including the above-mentioned newly added display mode of displaying a preview image with the use of icon-type image data. Thereby, user's convenience is improved, and a preview image display processing load is reduced.

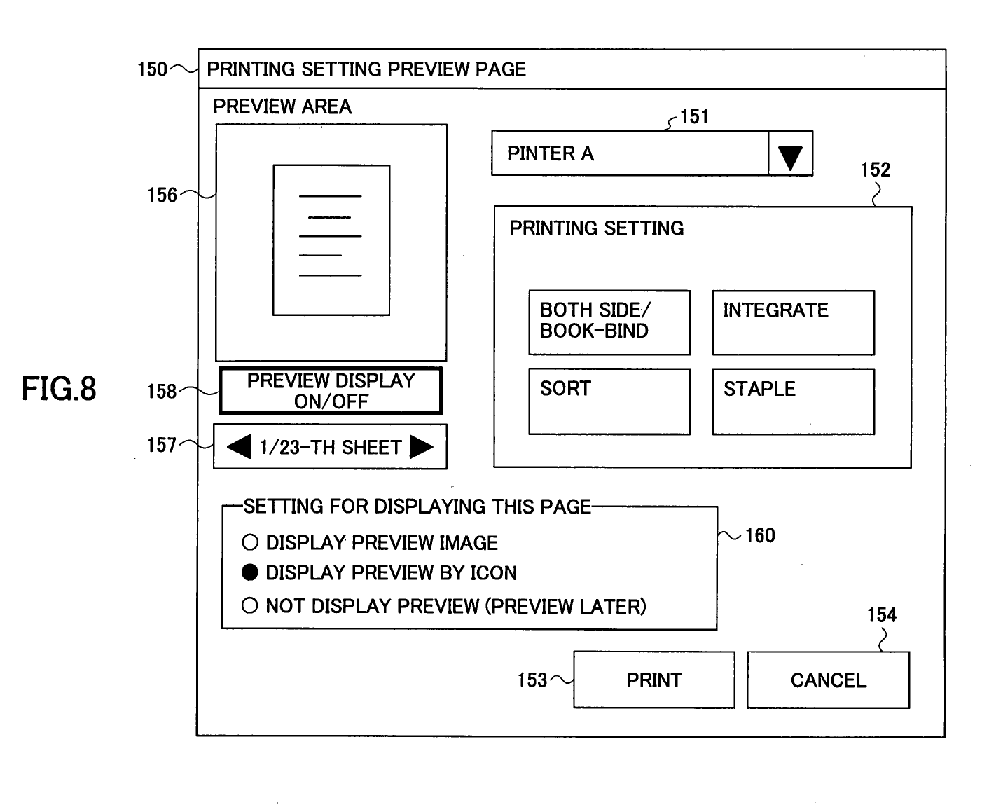

FIG. 8 shows a printing setting page in the third embodiment.

As shown, in the printing setting page 150 displayed, a check box 160 for previously selecting a preview display mode from among those including the mode with a display of a preview image by image data of icon type is provided instead of the check box 159 for previously selecting a preview image display mode (as to whether or not a preview display is made at the same time with a display of a printing setting page).

In the check box 160 for previously selecting a preview display mode, check items, i.e., ‘display a preview image’, ‘display a preview image by icon’ and ‘not display a preview image (preview later)’ are provided. One thereof is selected by a user and thus the selected display mode is set.

The icon-type image data corresponds to an image generated by icon data imitating a printing result from a printing condition such as post processing such as punching processing, stapling processing or such, a printing method such as integrating/both-side printing or such, setting of a paper type, a paper feeding tray, or such.

When the item ‘display a preview image by icon’ is checked from the check box 160, image data for displaying a preview image in the preview image display area 156 for printing preview of the above-mentioned printing condition is actually displayed, not as a result of conversion being carried out from intermediate data into preview image data but by icon-type image data previously prepared.

The icon-type image data may be prepared as a result of icons corresponding to printing setting contents selectable from the printing condition setting display field 152, such as integrating printing, both-side printing and so forth, being previously registered in the printer driver 122 or in the setting information DB 116. The registration of icon data may be carried out previously before the shipment of the product by the manufacturer, for example. Further, in order to allow a user to create or register icon data by himself or herself in an arbitrary scene, a corresponding API (Application Programming Interface) may be provided.

When a user gives an instruction for the preview display mode from icon-type image data, the printing setting module 112 obtains icon data of a printing condition registered in the printer driver 122 or the setting information DB 116 therefrom. Further, when printing condition setting is changed by a user, the printing setting module 112 obtains corresponding icon data corresponding to the printing condition each time when such setting change is made by a user.

By allowing selective usage of such icon-type image data, a user's request that a printing output state should be checked merely roughly can be met, and, for such a case, a time required can be further reduced in comparison to a case where a preview image is generated ordinarily from intermediate data.

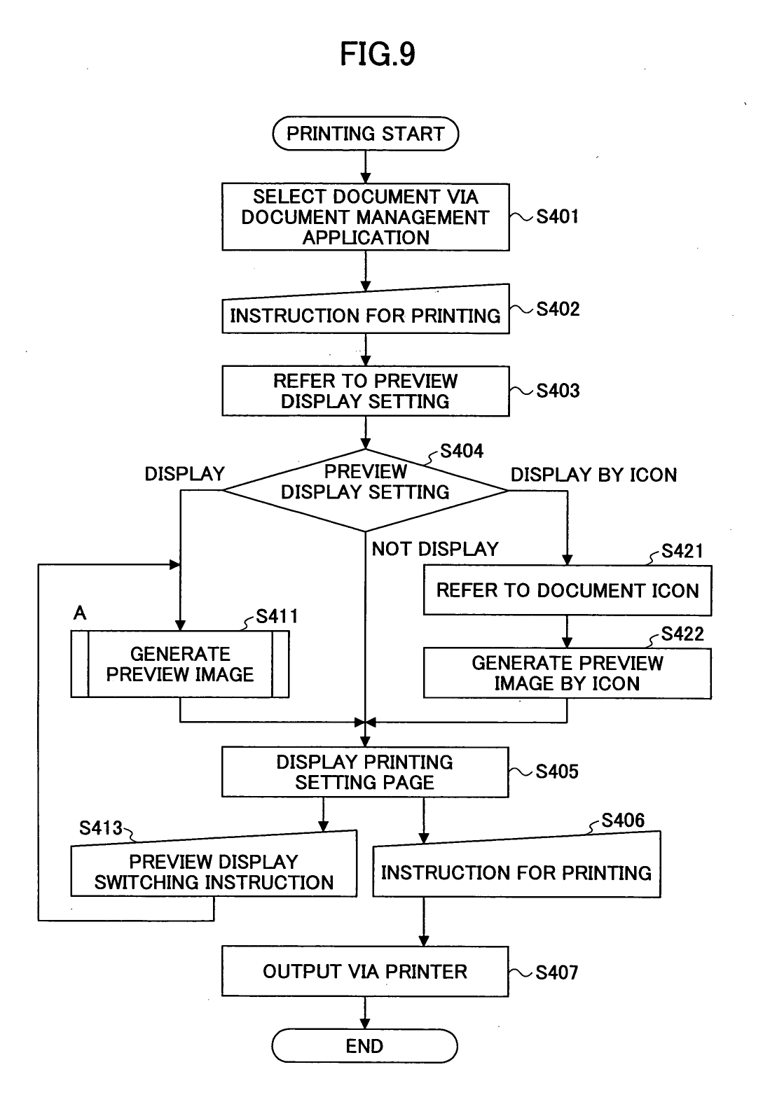

FIG. 9 shows a printing processing flow according to the third embodiment.

In this processing flow, processing of Steps S401 through S407 and S411 is carried out, i.e., processing is carried out for displaying a printing setting page according to a previous setting for selecting a display mode as to whether or not a preview image is displayed at the same time with a display of the printing setting page, and then, responding to a printing instruction made by a user from this page to output printing control data to the printer 200, basically the same as the printing processing (processing of the processing flow of FIGS. 4A and 4B) of the first embodiment. Accordingly, duplicated description is omitted by hereby referring to the description of the processing flow of FIGS. 4A and 4B.

Processing added in the third embodiment, i.e., processing carried out when the item of ‘display a preview image by icon’ is checked from the check box 160 (not included in the printing processing flow of FIGS. 4A and 4B of the first embodiment) is described now with reference to FIG. 9.

The printing setting module 112 refers to, from the setting information DB 116, a display mode setting for printing preview, previously stored as a result of input operation being made by a user on the check box 160 of the printing setting page 150 (Step S403).

When it is determined, from the referring, that a mode of displaying preview by icon is set (‘display by icon’ of Step S404), the printing setting module 112 obtains data corresponding to printing setting contents selected by a user from the printing condition setting field 152, from printing condition icon data registered in the printer deriver 122 or in the setting information DB 116 (Step S421). Next, the preview setting module 113 generates an image for a preview display by icon based on the icon data thus obtained (Step S422).

The printing setting module 112 carries out display control in such a manner as to output, in the preview image display area 156, preview image data by icon thus generated. As a result, a printing setting page with this preview image is displayed (Step S405).

The preview image produced by Steps S421 and S422 mentioned above after the mode of displaying a preview image by icon is selected, is generated from the icon data according to the printing setting contents selected from the printing condition setting display field 152 as mentioned above. In this case, the user cannot make, therefrom, a check for a printing output result made from the contents of relevant document data.

In order to allow such a check, a user's instruction is allowed for switching a preview display by icon into another preview display for a printing output result made from document data (i.e., a display of a preview image made in the first or the second embodiment). Then, from this instruction, the preview image by icon data displayed until then in the preview image display area 156 is replaced by a display of a preview display image generated from the contents of document data. This switching instruction may be input with the use of a switching button newly provided in the printing setting page 150, or, by utilizing the preview display ON/OFF button 158 in common.

Accordingly, a processing procedure from this switching instruction for a preview display image is such that, in the processing flow of FIG. 9, after Step S405 of displaying the printing setting page 150, user's pressing of the preview display image display switching button is detected, and, from this detection, an event that an instruction for switching the preview image is given, is recognized (Step S413).

In response to this preview display image display switching instruction, Step S411 of generating a preview display image for making a preview display of a printing output image from the contents of document data in the preview image display area 156 is carried out. This processing and processing carried out thereafter corresponds to the processing of displaying a preview image and processing responsive to a printing instruction, carried out in the first or second embodiment, and thus, duplicated description is omitted by referring hereby to the description of the corresponding description. However, new processing for combining or superimposing displayed images may be added in the preview image generating processing in order to allow a display manner such that an icon-type preview image is displayed in combination with or in superimposition with a preview display of printing output image.

In the above-described embodiments, the user's computer is directed to. However, the same functions may be mounted in a server computer connected via a communication network. Further, the functions of the document management application may be mounted in a printer or in an apparatus having a printing function, and the printer or the apparatus having the printing function may be used as a client.

Further, the present invention is not limited to the above-described embodiments, and variations and modifications may be made without departing from the basic concept of the present invention claimed below.

The present application is based on Japanese Priority Applications Nos. 2004-286037 and 2005-248610, filed on Sep. 30, 2004 and Aug. 30, 2005, respectively, the entire contents of which are hereby incorporated herein by reference.

What is claimed is:

1. A printing control apparatus comprising:
a registering part registering setting information concerning preview display of document data; and
a printing setting part responding to a printing request for the document data to output, to a display part, an printing setting page for setting printing conditions for the document data, wherein:
said printing setting part refers to the setting information registered in said registering part when receiving a printing instruction for the document data, and outputs the printing setting page providing a button for receiving an instruction for preview display of the document data without actually carrying out preview display of the document data when preview display of the document data has not been set in the registering part.

2. The printing control apparatus as claimed in claim 1, further comprising:
a converting part converting the document data for which the printing instruction has been received, into intermediate data; wherein:
said printing setting part responds to an instruction for preview display of the document data by means of said button, to send an instruction to said converting part for converting the document data into intermediate data and generate a preview image to be applied for preview display of the document data, based on the intermediate data obtained from the converting part, responding to the instruction.

3. The printing control apparatus as claimed in claim 1, wherein:
said printing setting part outputs a printing setting page by which a selection can be made for preview display with icon data in imitation of the preview image, instead of preview display with the preview image itself

4. A computer readable information recording medium storing therein a program for causing a computer to function as the printing control apparatus claimed in claim 1, said program comprising instructions for causing the computer to function as:
said registering part registering setting information concerning preview display of document data; and
said printing setting part responding to a printing request for the printing data to output, to a display part, an printing setting page for setting printing conditions for the document data, wherein:
said program comprises instructions for causing said computer functioning as said printing setting part to refer to the setting information registered in said registering part when receiving a printing instruction for the document data, and, output the printing setting page providing a button for receiving an instruction for preview display for the document data, without actually carrying out preview display of the document data when preview display for the document data has not been set in the registering part.

5. The computer readable information recording medium as claimed in claim 4, wherein:
said program further comprises instructions for causing the computer to function as:
a converting part converting the document data for which the printing instruction has been received, into intermediate data;
said program further comprises instructions for causing the computer functioning as the printing setting part to respond to an instruction for preview display of the document data by means of said button, to send an instruction to said converting part for converting the document data into intermediate data, and generate a preview image to be applied for preview display of the document data, based on the intermediate data obtained from the converting part, responding to the instruction.

6. The computer readable information recording medium as claimed in claim 5, wherein:
said program further comprises instructions for causing the computer functioning as the printing setting part to output a printing setting page by which a selection can be made for preview display with icon data in imitation of the preview image, instead of preview display with the preview image itself.
